(19) United States
(12) Patent Application Publication
(10) Pub. No.: US 2007/0168436 A1
(43) Pub. Date: Jul. 19, 2007

(54) System and method for supplying electronic messages

(75) Inventor: Kenneth Andam, Highland, UT (US)

Correspondence Address: THORPE NORTH & WESTERN, LLP., 8180 SOUTH 700 EAST, SUITE 200, SANDY, UT, 84070, US

(73) Assignee: WorldVuer, Inc.

(21) Appl. No.: 11/337,052

(22) Filed: Jan. 19, 2006

(51) Int. Cl. G06F 15/16

(52) U.S. Cl. 709/206

(57) ABSTRACT

A system and method are provided for supplying electronic messages to a message recipient. The system includes a message server configured to distribute electronic messages. A plurality of electronic messages can be stored on the message server, and the plurality of electronic messages include video output for the message recipient. A message header can be stored on the message server for each electronic message. The message header refers to message blocks for message content and video output. A message client is also configured to first receive the message header when an electronic message is sent to the message recipient and to request the message blocks from the message server when the electronic message is accessed by the message recipient.

### FIELD OF THE INVENTION

The present invention relates generally to electronic communication.

### BACKGROUND

Email systems have become more important to business and personal life than ever. In particular, many businesses rely on email communication to conduct transactions and meet their business objectives quickly. As email use has grown, users have desired greater reliability and functionality from their email systems. However, because legacy email systems are based on older messaging protocols and communication architectures, it has been difficult for the software industry to improve upon existing systems while maintaining compatibility with the legacy email systems. This is due in part to the many older protocols and architectures that are so deeply ingrained into current information technology systems.

Instead of improving text email systems to carry additional multimedia elements, parallel messaging systems have been developed to provide electronic chatting technology, video conferencing, and interaction on graphic whiteboards. The creation of such tools only adds to the cost and complexity of the information technology systems that need to be maintained. In addition, these systems do not necessarily maintain backwards compatibility with present email and messaging systems.

The current defacto standards for email systems use aging Internet protocols that provide little or no security for the transfer of messages. In addition, the legacy email systems do not allow for confirmation of the receipt of messages. Legacy email systems also provide little in the way of security or control for the transfer of messages.

This lack of security in email systems manifests itself in symptoms such as unwanted emails or Spam. Many users desire a system with a better way of coping with the Spam problem. Users would like to only receive emails from contacts they want to receive messages from. In addition, individuals should be able to send emails that are legitimate contacts even when the email is being sent for the first time.

Email systems have remained in the realm of text messages with files that can be attached to the emails. Text messages have been available to be sent through the Internet using email clients since the 1960's and multimedia capabilities have been available on computer systems since the early 1990's. However, combining video and graphic capabilities into useful messaging systems that are easily employed by large groups of people has remained a challenge.

### BRIEF DESCRIPTION OF THE DRAWINGS

FIG. 1 is a block diagram illustrating an embodiment of a system for supplying electronic messages to a message recipient;

FIG. 2 is an illustration of a compose screen in a message client in accordance with an embodiment of the present invention;

FIG. 3 is an illustration of a send and retrieve process in an embodiment of the present invention;

FIG. 4 is an illustration of an exemplary message client with a preview pane; and

FIG. 5 is a flowchart illustrating an embodiment of a method for supplying electronic messages to a recipient.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention relates to the sending and receiving of electronic messages with features such as audio, video, contact information exchange, email retraction, and message forwarding restrictions. The present system and method can allow users to securely exchange audio, video, multi-media messages, as well as text.

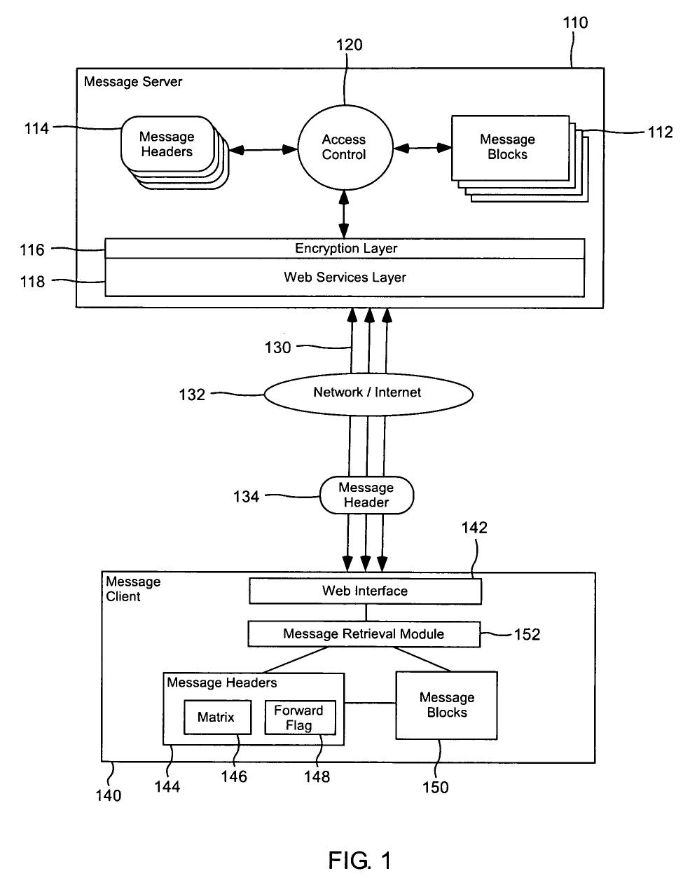

FIG. 1 is a block diagram illustrating an embodiment of a system for supplying electronic messages to a recipient. The electronic messaging system can include a message server 110 that is configured to distribute electronic messages. Video, audio, still images, multi-media, and text messages can be integrated into the messaging system using a web client and web based server application. The web based server application may use a web services architecture. A plurality of electronic messages can also be stored on the message server. The plurality of electronic messages can provide message output (video, audio, etc.) to the message recipient.

One or more message headers 114 can be stored on the message server for each electronic message. The message header can refer to message blocks 112 or message segments for the message contents and video output. The message blocks can include text, audio, video, animations, diagrams, attachments, or other electronic messages. In one example, the message blocks can be 100K in size and/or the blocks may be Advanced Encryption Standard (AES) encrypted.

A web services layer 118 may be provided to communicate with client programs remotely located across a network or the Internet. A web services application can be made available to receive remote procedure calls from a message client 140. Object oriented remote procedure calls can also be used such as (DCOM, Corba, Java RMI), or messaging (MSMQ, MQSeries) may be used. These remote procedure calls can be made using Hyper Text Transfer Protocol (HTTP) or a similar web protocol. In addition, the web services used in the present invention may be defined by Web Service Description Language (WSDL). However, the web services implemented for the present invention are not necessarily limited to such languages. Using web services avoids the restrictions that are inherent in more rigid legacy email protocols such as SMTP, MIME, IMAP or similar protocols, but the improved message system can be used in conjunction with or as an overlay to known email protocols.

The message server 110 can also be called a video database server (VDS). The user or message recipient has the ability to choose different video, audio, text, or animated sources when composing a new message for greater flexibility. For example, stored video or audio may be selected as the message source or an active recording device like a video recorder or audio recorder may be used.

An encryption layer 116 can also be provided to encrypt message blocks as they are sent to the message client. The encryption used can be any encryption method known to those skilled in the art. Each message body, attachment, and video may be individually encrypted for transfer and storage. The key to decrypt each of these messages is passed securely to the server and retained only by the server and recipients. The decryption key is a combination of numerical values and text that is generated using a random selection of structured components of a user's username and password when they log on to the system. The generated values create an assigned key code embedded in the message being sent. When a recipient of a message accesses the message in their receiving message box, the embedded key code activates a structure query of the recipients contact identity and releases the massage header request for the body of the message to be delivered. Each message may contain one or more coded key codes based on the priority set forth on the message being sent.

The database structure of the message server allows a current message window displayed in the message client to play a message history on the same topic automatically. In other words, all the stored emails from a selected thread can be played back from a single message window. A thread can be generally defined as all of the emails sent and replied to for a given message topic. Messaging threads for audio and video mail messages can also be provided.

The message client 140 can be in communication with the message server 110 over a network, Local Area Network (LAN), Wide Area Network (WAN), or the Internet 132. The message client may be configured to first receive a message header 134 when an electronic message is sent to a recipient. This means that the actual message content is not sent until a message is accessed. For example, if a user receives a Spam email then the user may delete the message header without opening it. In this situation, the message header alone is deleted and the message content is not transferred to the client. This reduces bandwidth needed by the client and only desired email contents are transferred to the message client. In addition, the dangerous contents of Spam emails can avoid being transferred to the message client.

The web services architecture also enables multiple communication channels 130 to be created for transmitting data between the message server 110 and the message client 140. Each separate web service connection can send a different type of data. For example, one channel may send text, a second channel may send audio, and a third channel may send video. The multi-channel architecture can increase the overall throughput from the message server to the message client. A multi-channel architecture can also make the system more robust.

When a message recipient or user accesses a particular message, the message retrieval module 152 of a client can request the message blocks 150 or segments containing the actual message. This request is fulfilled via a client web interface 142.

The message header 144 can include a matrix 146 that refers to the message blocks that one requested and assembled to provide the actual message. A reconstruction process can be used to reassemble the message blocks that are needed to reproduce a message (e.g. audio, video, text).

The matrix 146 assists in resuming a terminated message download via the web services or other network transfer protocols. For example, the matrix can track which message blocks were actually received and then the message client can request a re-transmission of any message blocks that were not received. Error correction for the data may also be included at this level. The matrix also allows the message blocks to be downloaded by the message client in an out-of-order pattern. Allowing the message blocks to be downloaded in any order overcomes many of the problems associated with streaming video that has been used in other types of video mail systems. With streaming media, users are dependent on real-time network connectivity and the system's ability to cache messages when the network is down. During message relaying on such systems, packets most often get lost in the transport phase.

This messaging system provides a way for the sender to prevent a message from being forwarded when the sender desires to keep the message private. In one embodiment, the system has an access control module 120 to restrict the forwarding of messages. Since the message blocks (e.g., video and audio) are downloaded from the message server then a restriction set by the message sender may be processed by the message server.

When a request is received for forwarding a message, then the access control module can check and see whether the sender has allowed the message to be forwarded. If the sender has requested that the message should not be forwarded, the message will be blocked. In other words, the message blocks for the specific message can be blocked from being forwarded. The blocking is particularly effective because a recipient only receives a header first.

The message client may also block the forwarding of the message header and any stored message blocks using a forward flag 148. The forward flag can be checked at the message server or the forward flag can also be checked at the client level to block forwarding.

Contact management and privacy functions are included in the present system and method to allow users to exchange contact information and keep it up to date seamlessly through the messages being sent back and forth.

Users of the messaging system can prevent unwanted email or Spam from being received by using a contact approval system that allows a contact to be accepted by the recipient before email is actually received from a sender. The contact approval system can include a contact list that may be presented to the message recipient or user of the message client. This list includes the names of individuals who have sent a message to the user, and the list represents contacts for which approval is pending. If the user approves of a contact, then any further emails from the contact will not have to pass through the approval process again. The present system allows the user to view every contact that sends them a message and to then make a decision based on the contact name and/or message subject line.

One benefit of a pending contacts approval list is that it does not create extra work for a message sender and the list adds just a minimal amount of filtering time for the message recipient. The contact approval system is also valuable because it does not move email into a Spam folder which can sometimes cause messages to get lost. Senders are not asked to prove that the sender is actually a human by solving some graphic puzzle or by replying to an additional email.

The use of a message header in the present system and method allows the web services to recover from an abnormal termination of the network communications. Many video and audio communication services over a data network can be terminated due to the packet switching and routed nature of current networks. If such a disruption occurs, data is often lost and the communication channel is terminated. When a large stream of information (such as a video) is sent over a web services link, then it may be difficult to recover the data stream or connection. Under current architectures, the data stream is resent from the beginning. However, the use of the message header allows the present invention to quickly recover and start requesting the lost data or message segments over a new web service connection at the point in the data where the interruption occurred.

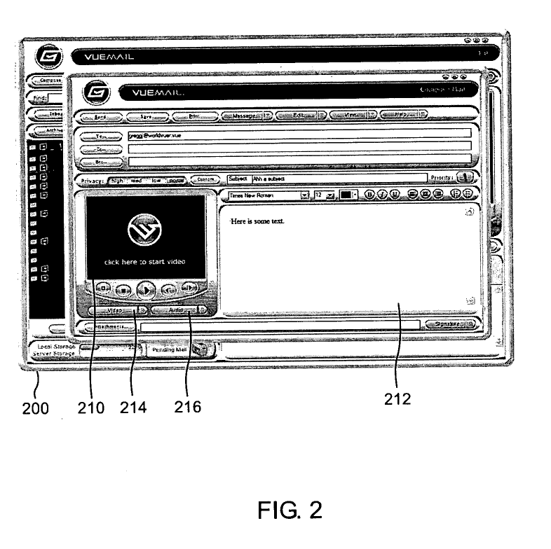

FIG. 2 illustrates an example compose screen 200 for a new message. The compose screen can have a video recording and playback screen 210 as well as a text editor 212 for written messages. This compose screen can have the ability to record or capture visual messages from video, from a file, from a peripheral, or from the computer desktop, and the ability to record sound from a file or peripheral. For example, a video control 214 and audio control 216 can be provided to select the source of audio and video message material. These options allow users to create music videos, software instructional videos, and narrate movies, as well as just send a personal video of themselves.

The messaging system can have integrated advertising that plays on the video playback screen 210 when the screen is not in use for personal messages. Users can click on these advertisements to purchase advertised items or find out more information about a product or service. The messaging system can also be directly connected to an e-commerce transaction and product engine that allows a user to purchase an item that has been selected.

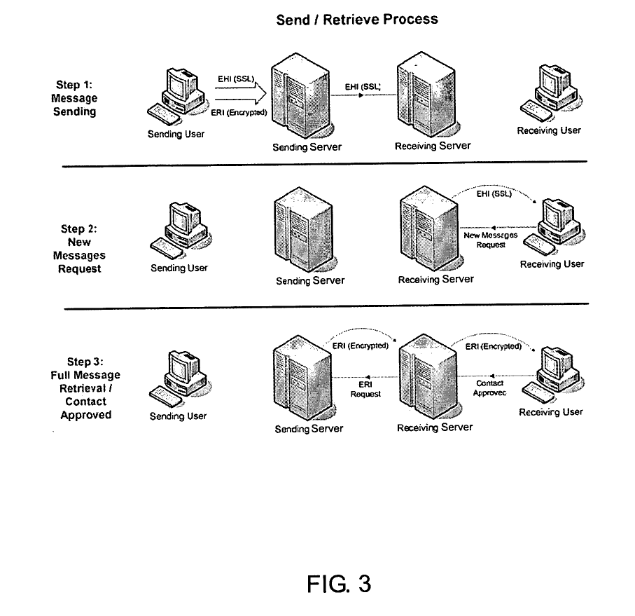

FIG. 3 provides a more detailed example of the send and retrieval processes described previously for the messaging system. Step 1 depicts the creation of an email message by a sender. Once the email has been created, a random 10 to 15 character alphanumeric encryption key is generated for that specific message. The message can then be divided into two parts. The first and smaller part is the message header or email header information (EHI) which includes fields for information such as the From, To, Cc, Bcc, Subject, Previous Email ID, Type, Priority, Forward Lock, and the encryption key.

The second and larger part of the message is the message blocks or segments. These message blocks include the email resource information (ERI) which includes the message body, attachments, and/or video. The message body, attachments, and video are independently encrypted with respect to the message header or EHI. The separate storage locations for the EHI and ERI also add an additional layer of security.

In the example email transfer of Step 1, the EHI can be first sent through a Secure Socket Layer (SSL) connection to the message server or database server for the sender's domain. The ERI may be sent independently through an unencrypted web services connection to the message server for the sender's domain because the ERI is encrypted already. Because of the transmission overhead in the SSL connection, the small file size of the EHI is valuable because it allows the EHI to be transferred quickly.

When the recipient of the email is outside the sender's domain, the sender's message server will contact the recipient's message server and first transfer the EHI to the recipient's email inbox.

In step 2 of FIG. 3, when the recipient chooses to get new email from their message server, the client program can retrieve the EHI from the recipient's message server. Steps 3 further illustrates that when the recipient chooses to read the message, then the recipient's message server can contact the sender's message server and retrieve the encrypted ERI. Users can determine whether they want to read a message based on the subject and sender identification. A log can also be created of the user or email address that is downloading the ERI or message body. This log provides a security audit trail.

The encrypted ERI data can then be transferred to the client machine. The ERI data is generally stored in an encrypted format, which provides high security and prevents modification of the original message contents even when the message is forwarded. The ERI can be decrypted when a user chooses to view the message using the messaging system client or messaging system web based program.

The fact that the ERI is not transferred until the recipient chooses to read a message gives the system at least two advantages. The first advantage is that although each user has a limited mailbox size, unread messages do not count against the user because only the header or EHI has been downloaded. This reduced initial message size allows a recipient to have a larger inbox than would otherwise be possible. Since many recipients can tell unwanted Spam email from the sender name and subject line, unread spam has less effect on the mailbox size.

The second advantage of separately sending the EHI first is that the email sender can choose to retract a message. Since the ERI or message contents do not reach recipients that have not yet read the message, the message can be completely retracted before the recipient reads the message. This is in contrast to legacy email systems where it is difficult to retract messages once they have left the originating mail domain. In addition, a recipient will not receive any notice that the message has been retracted because the header can be quickly and entirely deleted. In an alternative embodiment, if a message has been retracted after the header has been received, then the header can be retained and a simple message can be given that the message was retracted.

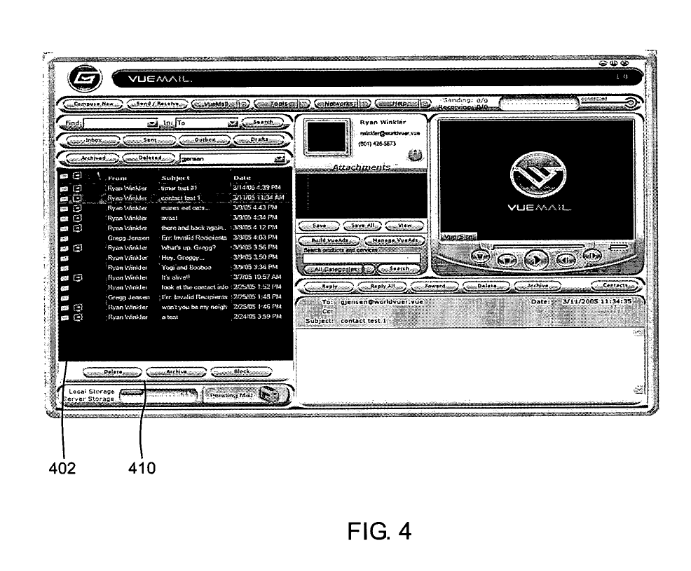

FIG. 4 illustrates an example of the client program with a preview pane. This client program will have a panel 402 to graphically display all of the attachments for a selected email. This attachment view can also allow the user to select and save multiple attachments at once. The program can have an attachment management section 410 which allows the user to manage attachment blocking based on file extensions. The user can choose to completely block an attachment from being retrieved, warn before opening an attachment, or allow the attachment to be opened easily.

If an attachment in the preview pane is supported by the messaging system, such as image files, audio, or video, the messaging system may open the attachment within the message client. If the attachment is not supported, the messaging system may launch the appropriate viewer program. The attachments may be accessed directly from the preview pane. This direct access is valuable because users often read an email and then need to access the attachments later but do not need to re-read the message.

The message client can be a dual mode system with the ability to send and receive email from both legacy email systems or protocols and the ability to process or manage the enhanced video and audio system. Emails received from legacy email systems (or prior email systems) can be stored encrypted on the client machine. However, the current server and client functionality is generally the same to process such legacy messages.

The present system also includes a pending contacts list for privacy control purposes. When a user gets a message from a sender that they have not accepted into their contact list, the message is stored as an unapproved contact for viewing by the user. Then the sender is unable to send any more messages to that user until the first message is accepted. This is a straight forward way for each user to control Spam without requiring the sender to take extra actions to get an email through to a recipient or user.

Each message can also send a specific amount of sender contact information based on the sender's privacy level settings. If the sender has a high privacy level, only information such as the recipient's email address is sent. If the sender has a low privacy level, then information such as a name, address, and phone number may be provided. This allows each user to keep the personal information from their contacts up to date in an automated manner. Other privacy levels can be provided as needed, and each level of privacy may supply different amounts of contact information that are sent out with a message.

Each message EHI or message header may contain a Previous Message ID. This previous message field can allow the user to play through an entire thread of messages or video on the same subject with one click. Each message in the history can contain an ID for the previous message, which creates a linked list of previous messages for the message history. This helps avoid lengthy user searches to browse a message history for a specific topic thread.

As discussed previously, the message EHI may contain a forward lock flag which can be set by the sender when composing the message. The messaging system can check this flag before allowing a recipient to forward a message. This prevents a private email from getting sent to anyone other than the intended recipients. In addition, the system may prevent any other methods of copying or saving of a private message when the forward lock flag is set. This helps avoid forwarding of the message using other electronic means.

The message server database can contain a domain table that lists all of the available video messaging domains. This table may be frequently updated by a primary video messaging server. Each video messaging server on a network or on the Internet may be registered with one or more primary video messaging servers. The primary video messaging server(s) may maintain a global blacklist for domains that send out or transfer high levels of spam. The domain table on a local video message server may also include a flag marking whether or not a given outside domain is allowed to communicate with the recipients' video messaging server. This allows each domain to maintain a semi-closed network and to only allow electronic messages from domains that the local domain has already granted approval to.

Another benefit of the video messaging domain table is that the table can store the public Internet Protocol (IP) for each domain in the messaging system. This allows the messaging system domains to have a .vue extension or another extension that is recognized only by systems using the messaging scheme described herein. In other words, the present messaging systems will not be registered in the worldwide Domain Name Server (DNS) system. Thus, the present system can resolve a video database file extension to a public Internet Protocol (IP) address using a database in the video server device. This adds to the overall security of the system and may reduce hacking attempts on the message servers.

As described previously, a video screen in a display window can be used to display advertisements that are distributed by the user's local message server and the primary video message server. When the message client is not playing a video, then each domain may have the ability to setup their own internal advertisements to be displayed to the users or message recipients. These advertisements may be linked directly to a transaction and product engine that is distributed with the messaging system or with the individual messages. If the user clicks on an advertisement, they will be immediately taken to the purchase screen for that product, or to a service page. The transaction engine can electronically maintain all of the user's purchases and shipping information for quick user purchasing. Privacy features for the users purchase and shipping information can also be included with the transaction engine.

Advertising distribution can also be arranged on a random basis. Video advertisements can alternatively be distributed based on a time range, loads on given message servers, and similar criteria. Ads may be distributed separately from a sales and/or transaction server.

In another embodiment, the ads can be provided in a list to users and the users may select ads to view. For example, a user may choose to view an advertisement that seems interesting to them. However, the actual message videos will generally have a higher priority than the advertising videos. The advertising videos may be scheduled to play when actual message videos are not being played.

Electronic skins can also be provided for the message client. These skins can be stored in a separate resource file. Since the skins are stored in a separate resource file, this allows the system to quickly replace the resource file at the request of the user which can immediately change the skin or graphical texture of the message client.

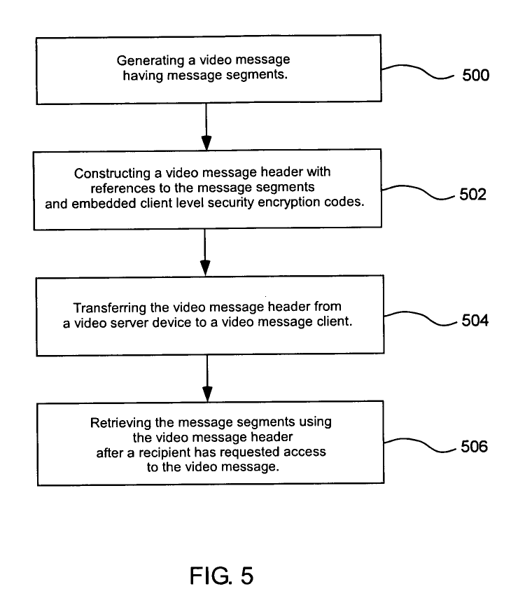

FIG. 5 is a flow chart illustrating a method for supplying electronic messages to a recipient. An initial operation in the method is generating a video message with message segments, as in block 500. Then a video message header can be constructed with references to the plurality of message segments and embedded client level security encryption codes, as in block 502. One or more message headers can be stored on a message server for each electronic message. The message header can refer to the message blocks or message segments containing the message contents and video output. The message blocks can include text, audio, video, animations, diagrams, attachments, or other electronic messages.

An additional operation is transferring the video message header from a video server device to a video message client in response to messages being sent or a direct request from the user using the message client, as in block 504. The message segments can be retrieved using the video message client and the video message header after the recipient has requested access to the video message, as in block 506. Because the message segments are stored on the video server devices until the video client requests the segments, this allows the video messages to be retracted before being read by a recipient. If the video message header is deleted before the message segments have been retrieved, then the recipient will not be able to ever access the message even if they have received a header.

An image of a message sender can be embedded in the video message header in order to identify the message sender to the recipient. Sender contact information and profile exchanging can be included along with the sender's picture based on security privacy levels set by the sender. In addition, the system can provide contact based message acceptance and blocking using a pending contacts list.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for supplying electronic messages to a message recipient, comprising:
a message server configured to distribute electronic messages;
a plurality of electronic messages stored on the message server, the plurality of electronic messages including video output for the message recipient;
a message header stored on the message server for each electronic message, the message header referring to message blocks for message content and video output; and
a message client is configured to first receive the message header when an electronic message is sent to the message recipient and to request the message blocks from the message server when the electronic message is accessed by the message recipient.

2. A system as in claim 1, wherein the message header further comprises a forward lock key to prevent forwarding of messages at a server level.

3. A system as in claim 1, wherein the message header further comprises a message matrix referring to message blocks, a previous email ID, and a message encryption key.

4. A system as in claim 3, further comprising a message retrieval module for retrieving message blocks as defined by the message matrix in order to enable an electronic message to be viewed.

5. A system as in claim 1, further comprising a secure Internet layer over which the message header is sent.

6. A system as in claim 1, further comprising a video message body that remains stored on the message server when the message header is sent to the message client.

7. A system as in claim 1, wherein the message client is able to retrieve and playback video, voice, graphics, and text using separate web services data streams.

8. A system as in claim 1, further comprising an advertisement viewer configured to display an advertisement in a video window within the message client when a video message is not being viewed by the message recipient.

9. An electronic messaging system, comprising:
a message server configured to provide web services to a network in order to distribute messages;
a plurality of electronic messages, stored on the message server, the plurality of electronic messages including video playback output to a recipient of the electronic messages;
a message header stored for each electronic message, the message header referring to message blocks for content of the electronic messages; and
a message client configured to first receive the message header and later obtain message blocks referenced by the message header via the web services when an electronic message is accessed by the recipient.

10. A system as in claim 9, wherein the web services are accessed using remote procedure calls made between the message client and the message server.

11. A system as in claim 10, wherein the remote procedure calls are made through a web protocol.

12. A method for supplying electronic messages to a recipient, comprising the steps of:
generating a video message having message segments;
constructing a video message header with references to the message segments and having embedded client level security encryption codes;
transferring the video message header from a video server device to a video message client in response to messages being sent; and
retrieving the message segments using the video message client and the video message header after the recipient has requested access to the video message.

13. A method as in claim 12, further comprising the step of enabling video messages to be retracted before being read by a recipient by deleting the video message header before the message segments have been retrieved.

14. A method as in claim 12, further comprising the step of providing sender contact information and profile exchanging.

15. A method as in claim 14, wherein the sender contact information released to a recipient is based on security privacy levels.

16. A method as in claim 14, further comprising the step of providing contact based message acceptance and blocking using a pending contacts list.

17. A method as in claim 12, further comprising the step of preventing the video messages from being forwarded by recipients of the video messages.

18. A method as in claim 12, further comprising the step of resolving a video database file extension to a public Internet Protocol (IP) address using a database in the video server device.

19. A method as in claim 12, further comprising the step of transferring the video message header through a secure communication channel for receipt by video message clients and video server devices.

20. A system for supplying electronic messages to a message recipient, comprising:
a message server configured to distribute electronic messages;
a plurality of electronic messages stored on the message server, the plurality of electronic messages including video output for the message recipient;
a message header stored on the message server for each electronic message, the message header referring to message blocks for message content and video output;
a message client is configured to first receive the message header when an electronic message is sent to the message recipient and to request the message blocks from the message server when the electronic message is accessed by the message recipient; and
an access control module, in communication with the message server, configured to limit forwarding of electronic messages from the message server using a forward lock key, as requested by a message sender.
